(19) United States
(12) Patent Application Publication
(10) Pub. No.: US 2009/0039069 A1
(43) Pub. Date: Feb. 12, 2009

(54) Multi-function toaster

(76) Inventor: Wen-Hsien Lin, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/889,085

(22) Filed: Aug. 9, 2007

(51) Int. Cl. A47J 37/07; F27D 1/00; F27D 19/00; H05B 3/68

(52) U.S. Cl. 219/393; 219/402; 219/414; 219/443.1

(57) ABSTRACT

The present invention is related to home appliance, in particular, to a multi-function toaster, which is designed not only for toasting bread, but also for frying eggs or cooking coffee. The present invention increases an electric oven to a lateral side of the toaster, the electric oven is formed with the electric oven integrally as a whole by injection molding. An electric circuit of the electric oven is connected to an electric circuit of the toaster. The present invention is aimed to combine the toaster with the electric oven altogether. Therefore, users can toast bread, at the same time, fry eggs or cook coffee, milk by the increased electric oven.

### FIELD OF THE INVENTION

The present invention is related to home appliance; in particular, to a multi-function toaster toasting bread, and its extension console is able to cook coffee, fry eggs.

### BACKGROUND OF THE INVENTION

Toaster is mainly used to toast bread. In use, a piece of toasts put in the spring-loaded tray inside the toaster, where the spring-loaded tray can be depressed or elevated. Through a handle, the spring-loaded tray can be pressed downward to carry pieces of toasts into a plurality of toast slots and grates. When the spring-loaded tray is depressed to a lower dead point, the toaster is electrified and started to toast the toasts. A relay starts working to take hold of the spring-loaded tray inside the toaster. Users are able to setup a timer for cooking time. When time is out, the direct current will be cut, the relay will s working, toastd toast and then pop up from the spring-loaded tray. It is convenient for people are in hurry.

For example, CN03216843.X entitled “toaster with safety mechanism” assigned to King-Chen Chiu et al. on Jun. 2, 2004; Chiu disclosed that a toaster takes advantages of a base insulator equipped with metal piece, pressure sensitive piece, control unit, timer circuit are in coordination with magnets and nodes to conduct current by pressing downward a press member of a support mechanism. Activating the timer circuit may induce magnetism of the magnet to attract metal pieces of the press member altogether. Electricity keeps transmitting through the nodes to an electric heating element, after a specific cooking time, pressing member is fixed to a dead point; no further pressure can be exerted to the pressing member. The magnet is therefore separated from the metal piece; where magnetism is not induced in betweens. Pressure-sensitive piece is drifted a little higher to interrupt a power supply between nodes, electric heating element stops heating.

In use, pieces of toasts put into toast slots of the spring-loaded tray, which is pressed downward by a handle, an attraction element attracts the spring-loaded tray to start toasting. After cooking time, the toasts pop-up from the toast slots.

However, we could understand this merchandise is endowed with only simplified function which is not able to process other kind of foods. In usual, people like to eat their breakfast with fried egg, fried ham, a cup of hot coffee, or a cup of hot milk. Those additional items are necessitated to implement other cooking utensils, for example, pan, electric cup, etc. As a result, such a simple breakfast may require a lot of home appliance, each of them should plug in a socket, power cords of the home appliances are easily entangled to each other. In addition, home appliances put back to closet one by one are follow-up trivial things.

Persons skilled in the art have provided multi-function toaster and heating element, for example, U.S. Pat. No. 6,838,644 entitled “Household sectional oven and warmer cooking apparatus” to Chung-Ting on Jan. 4, 2005, Ting proposed two different equipments combined all together as a whole to facilitate user's operations to toast bread and heat up hot dogs etc., at the same time.

Though toaster is popular in use, more functions can be provided to the toaster.

### SUMMARY OF THE INVENTION

Point against aforesaid problems, the present invention is to provide a multi-function toaster, which is a combination with an electric oven integrally as a whole, electric circuit of the electric oven is incorporated into electric circuit of the toaster.

When the toaster is combined with the electric oven, toasting bread and flying eggs, or cooking coffee, milk can be processed at the same time.

Electric circuits of the electric oven and the toaster are electrically in parallel connecting with each other to a common power source. Electric circuit of the electric oven includes a power switch, a timer, and a heating element. As the toaster is in parallel connection with the electric oven, there will be no interference in betweens. Users can preferably select one of them according to their demands.

A base of the electric oven is integrally formed with a housing of the toaster as a whole; the base includes a tray and a spring-loaded tray for receiving the heating element, where the heating element is mounted inside the spring-loaded tray. The spring-loaded tray has a plateau surface, the heating element is evenly disposed below the plateau surface, a frying pan and a warm-up cup are correspondingly put on the plateau surface.

Since the toaster is coupled with a micro heating element, so kitchenwares can be reduced.

### BRIEF DESCRIPTION OF THE DRAWINGS

FIG. 1: is a perspective view of the present invention;

FIG. 2: is a plane view of the electric oven with heating element increases to the toaster present invention;

FIG. 3: is a schematic view of the electric circuit of the invention;

FIG. 4: is a diagrammatic view of the frying pan on the electric oven in use; and

FIG. 5: is another diagrammatic view of the warm-up cup on the electric oven in use.

### DETAILED DESCRIPTION OF THE PREFERRED EMBODIMENTS OF THE INVENTION

Detailed description is described according to the appended drawings hereinafter.

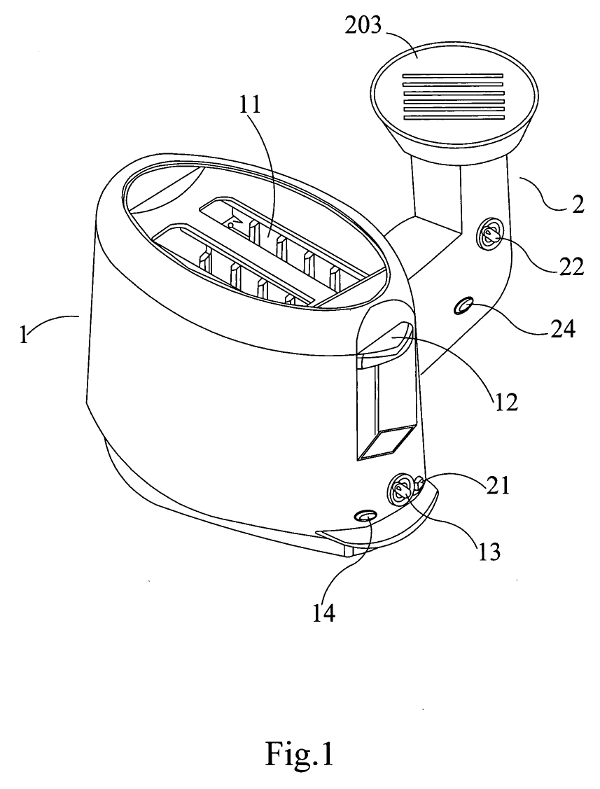

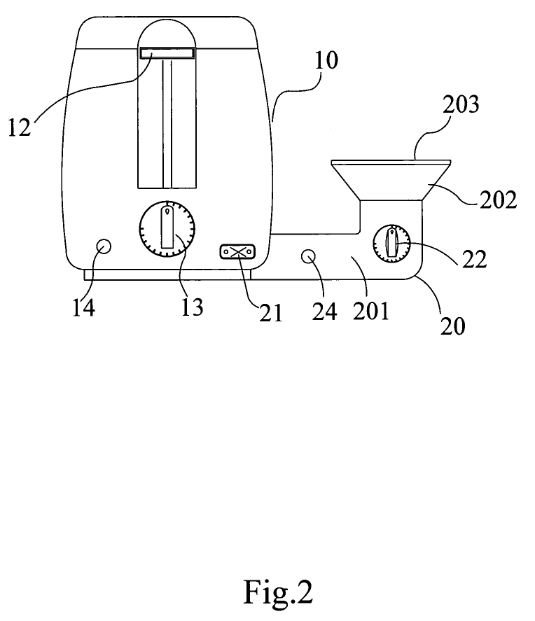

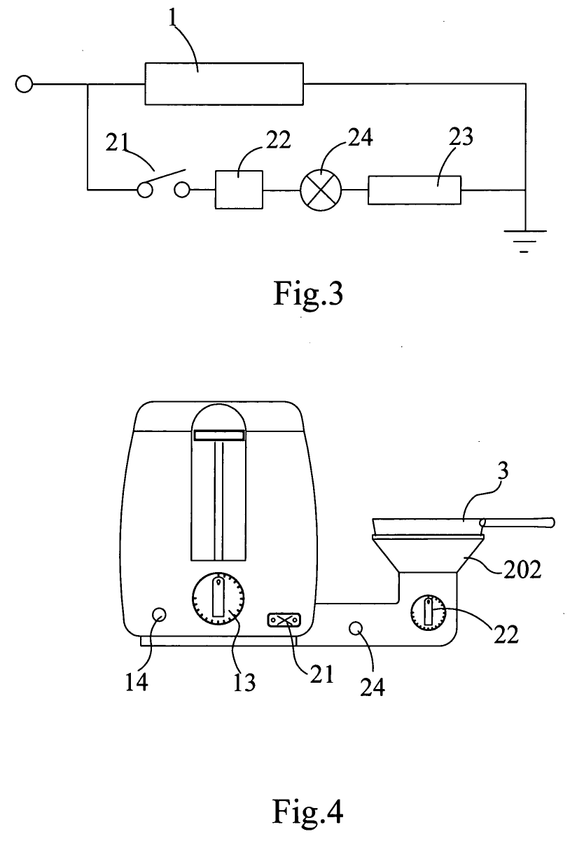

As shown in FIGS. 1-3, the present invention includes a toaster 1, and an electric oven 2. A multifunction toaster of the invention is mainly to combine the electric oven 2 to the toaster 1 integrally to form a new toaster. The toaster 1 includes a housing 10, bread toast slots 11, a heating element, a handle 12, a timer 13, and a light emitting diode (LED) 14. In the first embodiment, there are two toast slots 11 arrayed in parallel. Inside each of the toast slots 11, a spring-loaded tray can be driven upward or downward (not shown) is mounted inside the toast slot 11. When pressing a handle 12 downward, the spring-loaded tray is depressed to a lower dead point in contact with an electric power source to output power. A magnet attracts the spring-loaded tray to a lower portion of the toaster. Where pieces of bread are completely put in the toast slots 11, as the timer 13 is running to set a time limit for toasting bread. The heating element is mainly composed of resistors; when electrified, they generate heat to toast bread. At the same time, the LED 14 lights up. Till the set time is up, it cuts off the power supply. The magnet stops attracting the spring-loaded tray, which is therefore drifted upward, toastd bread pop-up out of the toast slots 11.

Electric oven 2 of the invention is electrically in parallel connection with the toaster 1, thereby, in use, the oven 2 and the toaster 1 will not interfere with each other. Electric circuit of the oven 2 includes a power switch 21, a timer 22, a heating element 23, and a light emitting diode (LED) indictor 24. Certainly, a thermostat can be added to the electric heating element 23, a button for controlling the thermostat can be correspondingly set on a base 20 of the oven 2.

When using, the switch 21 is first pressed downward, then sets a time limit with the timer 22. The heating element 23 and the LED indicator 24 are electrified, the electric heating element 23 starts heating up on the spot. Till the timer is time out, the power source is cut off, the heating element 23 stops heating. The LED indicator 24 is also darkened. In the electric circuit, the power switch 21 can be neglected or the timer 22 can be used instead of the switch 21 to turn on or off the electric circuit. Certainly, the timer 22 can also be neglected, only the switch 21 is used to determine a working period of the electric circuit instead of the timer 22. But, both timer 22 and switch 21 increased to the electric circuit can enhance safety mechanism to the electric circuit to facilitate users operating the toaster and the electric oven to heat up food items.

A housing 10 of the toaster 1 and a base 20 of the oven 2 are integrally formed as a whole by injection molding. Where a lateral side of the toaster 1 is extended to form the base 20 of the oven 2, which includes a tray 201 and a spring-loaded tray 202 for receiving the heating element 23. Bottom of the tray 201 is coplanar with a bottom of the toaster 1, by which the toaster and the oven can be placed on the same level steadily. The spring-loaded tray 202 has a small plateau surface 203; the electric heating element 23 is evenly disposed below the plateau surface 203.

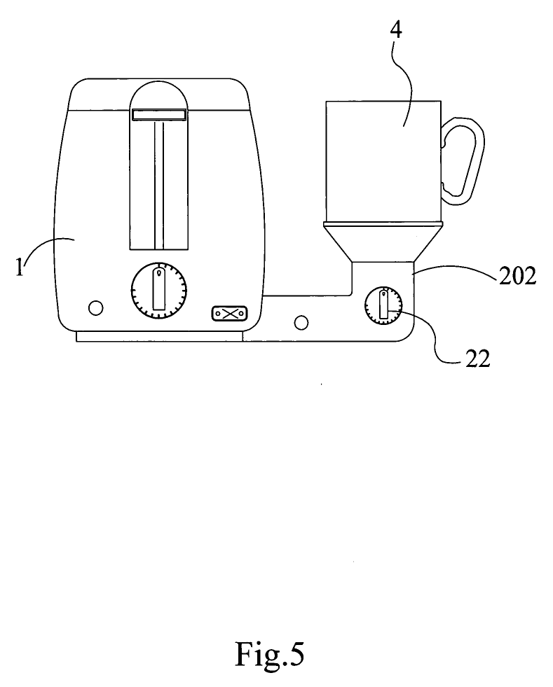

As shown in FIGS. 4-5, cooking utensils such as a frying pan 3 or a warm-up cup 4; can be added to the toaster. A bottom of the frying pan 3 is designed as large as an egg to facilitate frying eggs; a plateau surface 203 of the oven 2 has a size identical to the frying pan 3. Under such circumstance, size of a bottom of the warm-up cup 4 is identical to the plateau surface 203 of the oven 2.

The toaster 1 and the oven 2 can be combined together; therefore, we can toast the bread, and cook coffee, milk or fry egg at the same time.

What is claim claimed:

1. A multi-function toaster comprising: a toaster (1) characterized in that: an electric oven (2) is disposed to a lateral side of the toaster (1), the electric oven (2) is formed with the toaster (1) integrally as a whole, an electric circuit of the electric oven (2) is connected to an electric circuit of the toaster.

2. A multi-function toaster as claim 1 claimed wherein the electric circuit of the electric oven (2) is electrically connected to the electric circuit of the toaster (1) in parallel, the electric circuit of the electric oven includes a power switch (21), a timer (22) and a heating element (23).

3. A multi-function toaster as claim 2 claimed wherein a base (20) of the electric oven (2) is formed with a housing (10) of the toaster (1) integrally as a whole by injection molding, the base (20) includes a tray (201) and a spring-loaded tray (202) for receiving heating element, the heating element (23) is mounted inside the spring-loaded tray (202).

4. A multi-function toaster as claim 3 claimed wherein the spring-loaded tray (202) has a plateau surface (203), the heating element (23) is evenly disposed below the plateau surface (203); a frying pan (3) or a warm-up cup (4) is correspondingly disposed above the plateau surface (203).
